(19) United States
(12) Patent Application Publication
(10) Pub. No.: US 2025/0145200 A1
(43) Pub. Date: May 8, 2025

(54) WAGON LOCKING MECHANISM

(71) Applicant: THE RADIO FLYER COMPANY, Chicago, IL (US)

(72) Inventors: Fan Jianhua, Shao Xing City (CN); Yu Jiabin, Shao Xing City (CN)

(21) Appl. No.: 18/939,159

(22) Filed: Nov. 6, 2024

Related U.S. Application Data
(60) Provisional application No. 63/596,391, filed on Nov. 6, 2023.

(51) Int. Cl. B62B 3/00; B62B 3/02

(52) U.S. Cl. CPC B62B 3/007; B62B 3/025; B62B 2205/20

(57) ABSTRACT

A wagon frame locking mechanism to lock the wagon in a use position and unlock for allowing the wagon to transition to a folded position. The locking mechanism has a housing, a top cover secured to the housing, and a push button slidingly connected to the housing. A cam member is adjacent the handle housing, and a locking pin interacts with the cam member. When the push button is actuated, an extension engages the cam member to move the cam member longitudinally from a first position to a second position. A cam surface of the cam member engages the locking pin to axially remove the locking pin from a receiver in a slider member to allow the slider member to move linearly on the wagon frame to collapse the frame.

### CROSS-REFERENCE TO RELATED APPLICATIONS

This application claims the benefit of U.S. Provisional Patent Application No. 63/596,391 filed Nov. 6, 2023, which is expressly incorporated herein by reference and made a part hereof.

### FEDERALLY SPONSORED RESEARCH OR DEVELOPMENT

Not Applicable.

### TECHNICAL FIELD

The present subject matter relates to a locking mechanism, and more particularly, to a locking mechanism for a wagon to lock the wagon in the use and the storage position.

### BACKGROUND

Wagons and locking mechanisms for wagons are known in the art. While such products, according to the prior art, provide a number of advantages, they nevertheless have certain limitations. The present disclosure seeks to overcome certain of those limitations and other drawbacks of the prior art, and to provide new features not heretofore available. A full discussion of the features and advantages of the present disclosure is deferred to the following detailed description, which proceeds with reference to the accompanying drawings.

### SUMMARY

According to certain aspects of the present disclosure, the disclosed subject technology relates to locking mechanisms for wagons to assist in locking the wagon in a use position and unlocking for moving to a storage position.

The disclosed technology further relates to a wagon frame locking mechanism for a wagon, comprising: a handle housing having a first end and a second end; a first top frame member pivotally connected to the first end of the handle housing; a second top frame member pivotally connected to the second end of the handle housing; a lower support having a first end and a second end; a central frame member of the wagon having a first end and a second end, the first end of the central frame member being connected to a bottom of the handle housing and the second end of the central frame member being connected to a top of the lower support, the central frame member having an aperture; a slider member slidingly connected to the central frame member, the slider member having a first end, a second end, a central bore through which the central frame member extends, and a receiver; a first bottom frame member pivotally connected to the first end of the lower support; a second bottom frame member pivotally connected to the second end of the lower support; a first link member having a first end and a second end, the first end of the first link member pivotally connected to the first end of the slider member, and the second end of the first link member pivotally connected to the first bottom frame member; a second link member having a first end and a second end, the first end of the second link member pivotally connected to the second end of the slider member, and the second end of the second link member pivotally connected to the second bottom frame member; a carrier fixedly positioned within a bore of the central frame member, the carrier having a cavity; a cam member positioned within the cavity in the carrier, the cam member having a first end, a second end, a joining member connecting the first end and the second end, and an opening through the joining member, wherein the second end of the cam member has a cam surface, and wherein the cam member can transition generally linearly within the cavity in the carrier; a push button slidingly connected to the housing, the push button having an extension that engages the first end of the cam member; a locking pin positioned partially within the cavity of the carrier and extending through the opening in the cam member and the aperture in the central frame member, and into the receiver of the slider member in a use position to fix the slider member in a first position on the central frame member; and, wherein when the push button is actuated the extension engages the cam member to transition the cam member within the cavity of the carrier from a first position to a second position, wherein when the cam member transitions from the first position to the second position the cam surface of the cam member engages the locking pin to axially move the locking pin to an open position, and wherein the locking pin is removed from the receiver in the slider member to allow the slider member to move linearly on the central frame member to allow the wagon to collapse to a folded state.

The disclosed technology further relates to a wagon frame locking mechanism for a wagon, comprising: a handle housing having a first end and a second end; a central frame member of the wagon having a first end and a second end, the first end of the central frame member being connected to a bottom of the handle housing, the central frame member having an aperture; a slider member slidingly connected to the central frame member, the slider member having a first end, a second end, a central bore through which the central frame member extends, and a receiver; a cam member positioned within the central frame member, the cam member having a cam surface, wherein the cam member can transition generally linearly within the central frame member; a push button slidingly connected to the housing, the push button having an extension that engages the first end of the cam member; a locking pin partially extending through an opening in the cam member and the aperture in the central frame member, and into the receiver of the slider member in a use position to fix the slider member in a first position on the central frame member; and, wherein when the push button is actuated the extension engages the cam member to transition the cam member from a first position to a second position, wherein when the cam member transitions from the first position to the second position the cam surface of the cam member engages the locking pin to axially move the locking pin to an open position, and wherein the locking pin is removed from the receiver in the slider member the slider member is adapted to move linearly on the central frame member to allow the wagon to collapse to a folded state.

The disclosed technology further relates to a wagon frame locking mechanism for a wagon frame, comprising: a slider member slidingly connected to the wagon frame, the slider member having a receiver; a housing for the locking mechanism; a top cover secured to the housing; a push button slidingly connected to the housing, the push button moveable from a first position to a second position, the push button having an extension; bias members biasing the push button toward the first position; a cam member adjacent the handle housing, the extension of the push button engaging the cam member to move the cam member axially; a locking pin having a first end positioned in the receiver of the slider member to fix the slider member to the wagon frame in a use position, the locking pin engaging the cam member when the cam member is moved longitudinally by the push button, the locking pin moving linearly and transverse to the longitudinal movement of the cam member; and, wherein when the push button is actuated the extension engages the cam member to transition the cam member from a first position to a second position, and wherein when the cam member transitions from the first position to the second position a cam surface of the cam member engages the locking pin to axially move the locking pin to an open position wherein the locking pin is removed from the receiver in the slider member to allow the slider member to move linearly on the wagon frame member to allow the frame to collapse to a folded state.

The disclosed technology further relates to a wagon frame locking mechanism for a wagon, comprising: a first top frame member pivotally connected to the first end of the handle housing; a second top frame member pivotally connected to the second end of the handle housing; and, a lower support having a first end and a second end, wherein the second end of the central frame member is connected to a top of the lower support.

The disclosed technology further relates to a wagon frame locking mechanism for a wagon, comprising a first bottom frame member pivotally connected to the first end of the lower support, and a second bottom frame member pivotally connected to the second end of the lower support.

The disclosed technology further relates to a wagon frame locking mechanism for a wagon, comprising a first link member having a first end and a second end, the first end of the first link member pivotally connected to the first end of the slider member, and the second end of the first link member pivotally connected to the first bottom frame member, and a second link member having a first end and a second end, the first end of the second link member pivotally connected to the second end of the slider member, and the second end of the second link member pivotally connected to the second bottom frame member.

The disclosed technology further relates to a wagon frame locking mechanism for a wagon, comprising a carrier fixedly positioned within a bore of the central frame member, the carrier having a cavity, and the cam member positioned within the cavity in the carrier.

The disclosed technology further relates to a wagon frame locking mechanism for a wagon, wherein the cam member has a first end, a second end, a joining member connecting the first end and the second end, and an opening through the joining member, wherein the second end of the cam member has a cam surface, and wherein the cam member can transition generally linearly within the cavity in the carrier.

The disclosed technology further relates to a wagon frame locking mechanism for a wagon, wherein the locking pin is positioned partially within the cavity of the carrier and extends through the opening in the cam member and the aperture in the central frame member, and into the receiver of the slider member in a use position to fix the slider member in a first position on the central frame member.

The disclosed technology further relates to a wagon frame locking mechanism for a wagon, wherein when the push button is actuated the extension engages the cam member to transition the cam member within the cavity of the carrier from a first position to a second position, wherein when the cam member transitions from the first position to the second position the cam surface of the cam member engages the locking pin to axially move the locking pin to an open position, and wherein the locking pin is removed from the receiver in the slider member to allow the slider member to move linearly on the central frame member to allow the wagon to collapse to a folded state.

The disclosed technology further relates to a wagon frame locking mechanism for a wagon, comprising: a first top frame member pivotally connected to a first end of the housing; a second top frame member pivotally connected to a second end of the housing; a lower support having a first end and a second end; a central frame member of the wagon frame having a first end and a second end, the first end of the central frame member being connected to a bottom of the housing and the second end of the central frame member being connected to a top of the lower support, the central frame member having an aperture.

The disclosed technology further relates to a wagon frame locking mechanism for a wagon, wherein the slider member is slidingly connected to the central frame member.

The disclosed technology further relates to a wagon frame locking mechanism for a wagon, wherein the slider member has a first end, a second end, and a central bore through which the central frame member extends.

The disclosed technology further relates to a wagon frame locking mechanism for a wagon, comprising a first bottom frame member pivotally connected to the first end of the lower support, and a second bottom frame member pivotally connected to the second end of the lower support.

The disclosed technology further relates to a wagon frame locking mechanism for a wagon, further comprising a first link member having a first end and a second end, the first end of the first link member pivotally connected to the first end of the slider member, and the second end of the first link member pivotally connected to the first bottom frame member, and a second link member having a first end and a second end, the first end of the second link member pivotally connected to the second end of the slider member, and the second end of the second link member pivotally connected to the second bottom frame member.

The disclosed technology further relates to a wagon frame locking mechanism for a wagon, comprising a central frame member of the wagon frame, a carrier fixedly positioned within a bore of the central frame member, the carrier having a cavity, and the cam member positioned within the cavity in the carrier.

The disclosed technology further relates to a wagon frame locking mechanism for a wagon, wherein the cam member has a first end, a second end, a joining member connecting the first end and the second end, and an opening through the joining member, wherein the second end of the cam member has a cam surface, and wherein the cam member can transition generally linearly within the cavity in the carrier.

The disclosed technology further relates to a wagon frame locking mechanism for a wagon, wherein the locking pin is positioned partially within the cavity of the carrier and extends through the opening in the cam member and the aperture in the central frame member, and into the receiver of the slider member in a use position to fix the slider member in a first position on the central frame member.

The disclosed technology further relates to a wagon frame locking mechanism for a wagon, wherein when the push button is actuated the extension engages the cam member to transition the cam member within the cavity of the carrier from a first position to a second position, wherein when the cam member transitions from the first position to the second position the cam surface of the cam member engages the locking pin to axially move the locking pin to an open position, and wherein the locking pin is removed from the receiver in the slider member to allow the slider member to move linearly on the central frame member to allow the wagon to collapse to a folded state.

The disclosed technology further relates to a wagon frame locking, wherein the locking mechanism unlocks the slider member from the central frame member.

The disclosed technology further relates to a convertible mat, further comprising a first support adjacent the first insert panel and within the first cavity, and a second support adjacent the second insert panel and within the second cavity.

It is understood that other embodiments and configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### DESCRIPTION OF THE DRAWINGS

To understand the present disclosure, it will now be described by way of example, with reference to the accompanying drawings in which embodiments of the disclosures are illustrated and, together with the descriptions below are incorporated in and constitute a part of this specification, and serve to explain the principles of the disclosure. In the drawings:

FIG. 1 is a front top perspective view of a folding wagon, with a locking mechanism locking the wagon in the use mode, according to the present disclosure.

FIG. 2 is a bottom rear perspective view of the folding wagon of FIG. 1, with the locking mechanism locking the wagon in the use mode, according to the present disclosure.

FIG. 3 is a side view of the folding wagon of FIG. 1, with the locking mechanism locking the wagon in the use mode, according to the present disclosure.

FIG. 4 is a top front exploded view of the locking mechanism for the folding wagon mode, according to the present disclosure.

FIG. 5 is a bottom rear exploded view of the locking mechanism for the folding wagon mode, according to the present disclosure.

FIG. 6 is a mid-plane cross-sectional view of the locking mechanism in the unactuated position, with the cross section through a center of the slider, according to the present disclosure.

FIG. 7 is an offset cross-sectional view of the locking mechanism in the unactuated position, with the cross section through a side of the carrier and outside slider, according to the present disclosure.

FIG. 8 is a mid-plane cross-sectional view of the locking mechanism in the actuated position, with the cross section through a center of the slider, according to the present disclosure.

FIG. 9 is an offset cross-sectional view of the locking mechanism in the actuated position, with the cross section through a side of the carrier and outside slider, according to the present disclosure.

FIG. 10 is a side view of the folding wagon of FIG. 1 in the folded position, according to the present disclosure.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

While this disclosure is susceptible of embodiments in many different forms, there is shown in the drawings and will herein be described in detail preferred embodiments with the understanding that the present disclosure is to be considered as an exemplification of the principles of the disclosure and is not intended to limit the broad aspect of the disclosure to the embodiments illustrated. It should be noted that the features illustrated in the drawings are not necessarily drawn to scale, and features of one embodiment may be employed with other embodiments as one of ordinary skill in the relevant art would recognize, even if not explicitly stated herein. Further, descriptions of well-known components and processing techniques may be omitted so as to not unnecessarily obscure the embodiments of the present disclosure. The examples used herein are intended merely to facilitate an understanding of ways in which the present disclosure may be practiced and to further enable those of ordinary skill in the art to practice the embodiments of the present disclosure. Accordingly, the examples and embodiments herein should not be construed as limiting the scope of the present disclosure, which is defined solely by the appended claims and applicable law.

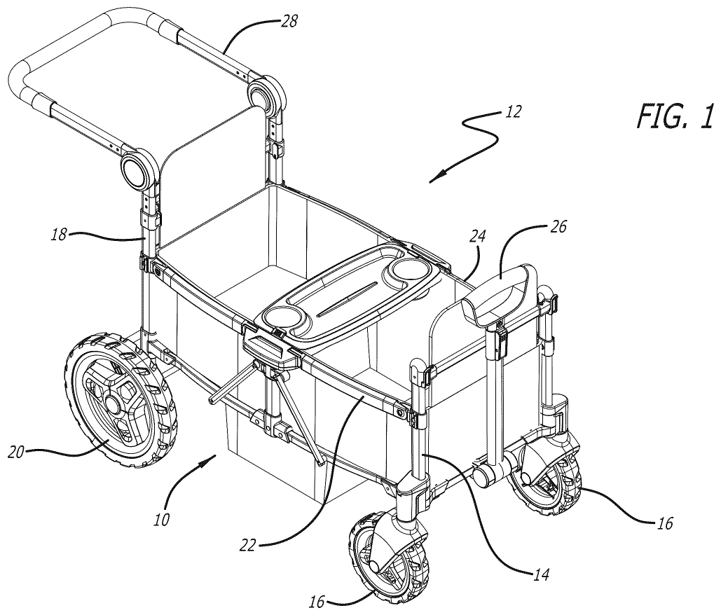

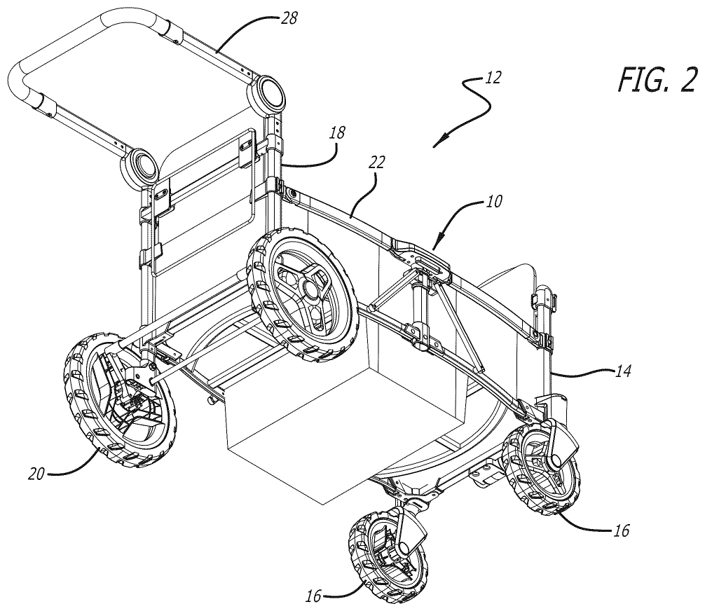

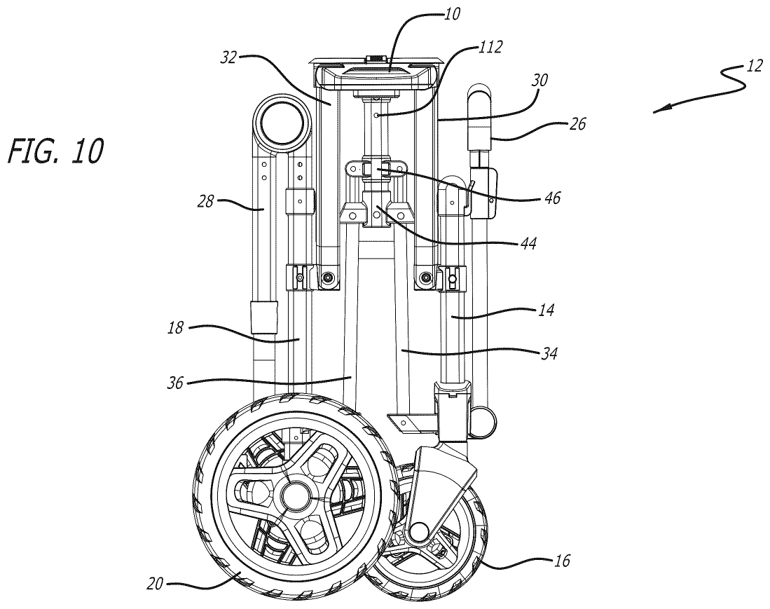

Generally, this disclosure describes a locking mechanism 10 for a folding wagon 12. The locking mechanism 10 operates to lock the folding wagon 12 in the use position, as shown in FIGS. 1-3, and the locking mechanism 10 can be operated to allow the folding wagon 12 to transition to the folded position, as shown in FIG. 10.

Referring now to the figures, and initially to FIGS. 1-3, there is shown an embodiment of the folding wagon 12. The folding wagon 12 has a front frame 14, two front wheels 16 connected to the front frame 14, a rear frame 18, two rear wheels 20 connected to the rear frame 18, a first side frame 22, and a second side frame 24. In one embodiment the folding wagon 12 also has a pull handle 26 pivotally attached to the front frame 14, and a push handle 28 connected to the rear frame 18. A locking mechanism 10 is provided for each side frame 22, 24 to secure the wagon 12 in the use position.

In one embodiment, the side frames 22, 24 each comprise a first top frame member 30, a second top frame member 32, a first bottom frame member 34, a second bottom frame member 36, a central frame member 38, a first link member 40, a second link member 42, a lower support 44, and a slider member 46. In one embodiment, the first top frame member 30 is pivotally connected to the front frame 14 at one end and pivotally connected to the locking mechanism 10 at the opposing end; the second top frame member 32 is pivotally connected to the rear frame 18 at one end and pivotally connected to the locking mechanism 10 at the opposing end; the first bottom frame member 34 is pivotally connected to the front frame 14 at one end and pivotally connected to the lower support 44 at the opposing end; and, the second bottom frame member 36 is pivotally connected to the rear frame 18 at one end and pivotally connected to the lower support 44 at the opposing end. Further, the slider member 46 is slidingly connected to the central frame member 38.

In one embodiment, the locking mechanism 10 operates to unlock the slider member 46 from the central frame member 38. When the slider member 46 is unlocked from the central frame member 38 the wagon 12 can fold as shown in FIG. 10 by raising the locking mechanism 10 and pivoting the first and second top frame members 30, 32 with respect to the locking mechanism 10 as well as pivoting the first and second bottom frame members 34, 36 with respect to the lower support 44. Because the first and second link members 40, 42 are pivotally connected to the first and second bottom frame members 34, 36, respectively, and to the slider member 46, when the first and second bottom frame members 34, 36 pivot the link members 40, 42 will operate to pull the slider member 46 down toward the lower support 44.

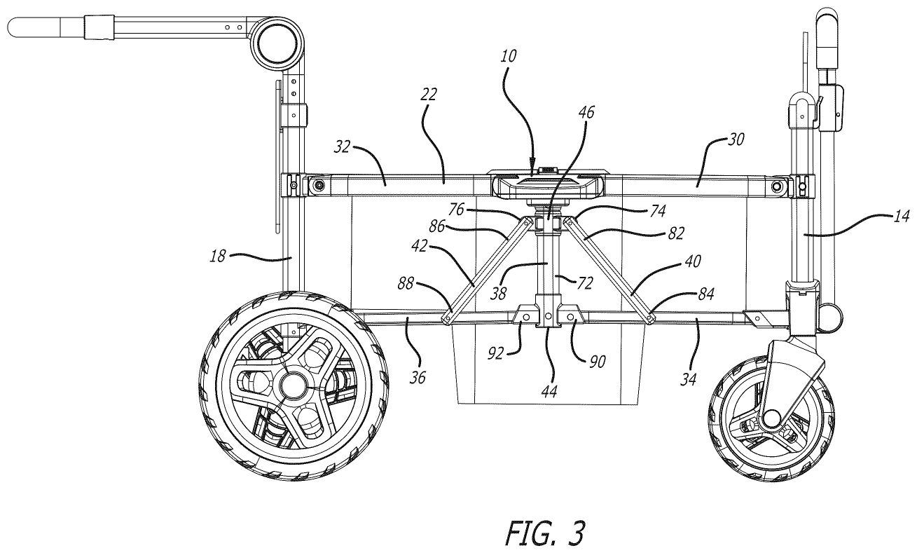

As best shown in FIGS. 3-5, in one embodiment, the locking mechanism 10 comprises a housing 50, a push button 52, a top cover 54, bias members 56 to bias the push button 52 away from the top cover 54, a carrier 58, a cam member 60, a locking pin 62, and a bias member 64 for the locking pin 62.

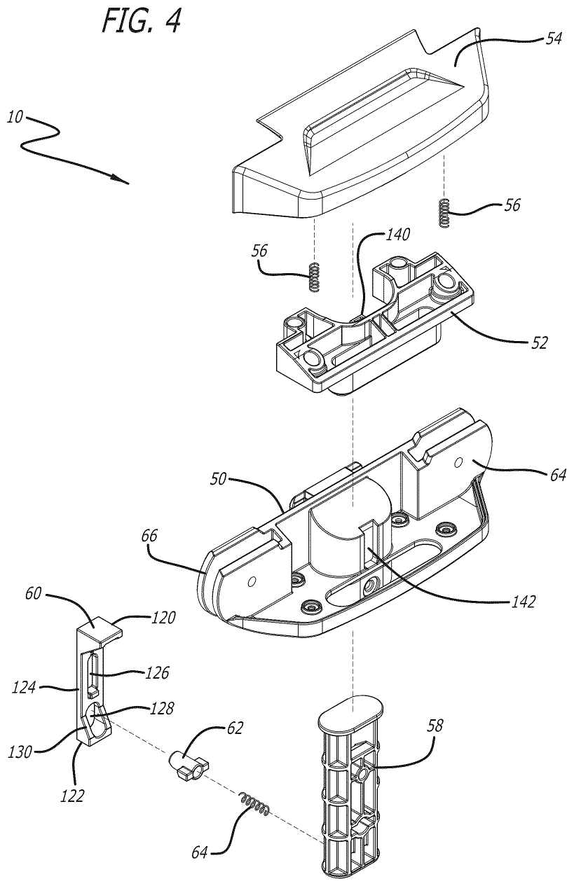

In one embodiment, as shown in FIGS. 3 and 4, the housing 50 has a first end 64 and a second end 66. In one embodiment the first top frame member 30 is pivotally connected to the first end 64 of the housing 50 and the second top frame member 32 is pivotally connected to the second end 66 of the housing 50. The housing 50 also has a lower opening 68. A first end 70 of the central frame member 38 is secured within the lower opening 68 of the housing 50. A second end 72 of the central frame member 38 is connected to the lower support 44.

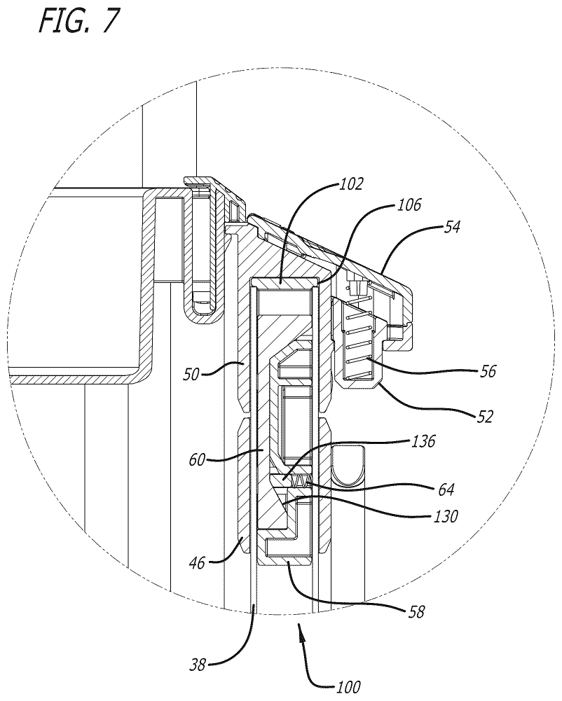

As shown in FIGS. 3 and 6-9, in one embodiment, the slider member 46 has a first end 74, a second end 76, and a central bore 78 through which the central frame member 38 extends. In one embodiment, the slider member 46 also has a receiver 80. In one embodiment, the first link member 40 has a first end 82 and a second end 84, and the second link member 42 has a first end 86 and a second end 88. The first end 82 of the first link member 40 is pivotally connected to the first end 74 of the slider member 46 and the second end 84 of the first link member 40 is pivotally connected to the first bottom frame member 34. Similarly, the first end 86 of the second link member 42 is pivotally connected to the second end 76 of the slider member 46 and the second end 88 of the second link member 42 is pivotally connected to the second bottom frame member 36.

As shown in FIGS. 1-3 and 10, the lower support 44 has a first end 90 and a second end 92. The first bottom frame member 34 is pivotally connected to the first end 90 of the lower support 44, and the second bottom frame member 36 is pivotally connected to the second end 92 of the lower support 44. As explained above, a second end 72 of the central frame member 38 is connected to the lower support 44.

Referring back to the locking mechanism 10, as shown in FIGS. 4-9, the top cover 54 is secured to the housing 50, and the push button 52 is sandwiched in between and able to move linearly therebetween. Bias members 56 bias the push button 52 away from the top cover 54. The top cover 54 has a plurality of posts 96 that extend to the housing 50, and the push bottom 52 has a plurality of mating openings 98. The posts 96 pass through the openings 98 in the push button 52 to allow the push button 52 to ride linearly on the posts 96.

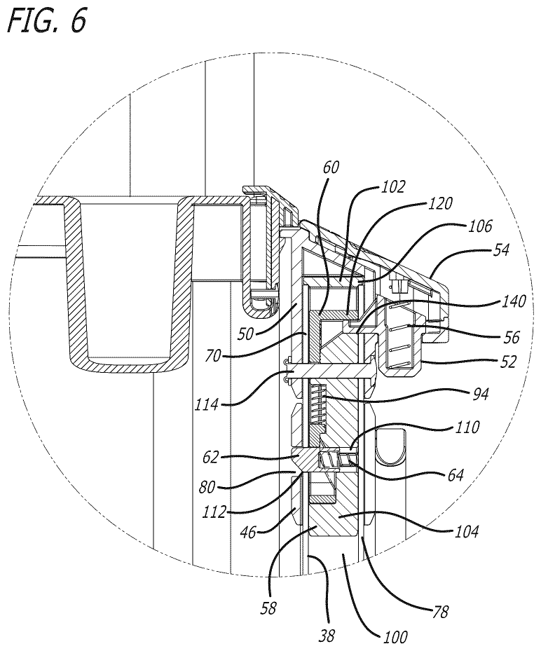

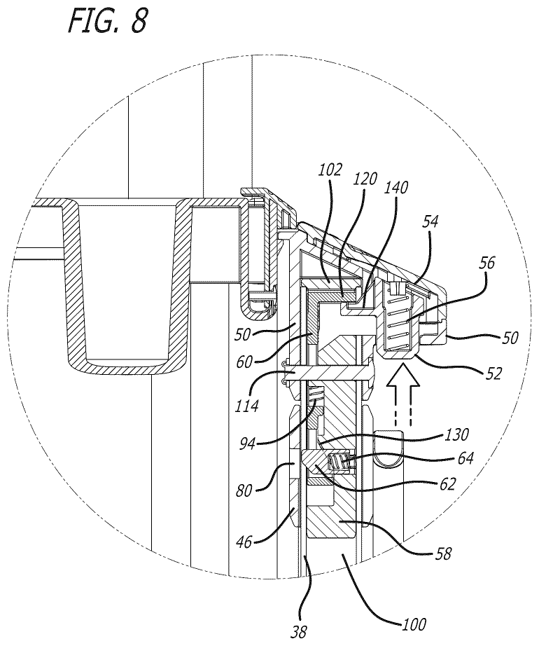

As shown in FIGS. 6-9, in one embodiment, the central frame member 38 has a bore 100, and the carrier 58 is fixedly positioned within the bore 100 of the central frame member 38. In one embodiment, the carrier 58 has a first end 102 and a second end 104. A lip 106 is provided at the first end 102 of the carrier 58, and the lip 106 sits on a top of the central frame member 38. The carrier 58 has a cavity 108 between the first end 102 and the second end 104 to slidingly receive the cam member 60. The carrier 58 also has an opening 110 to receive the locking pin 62, and a bias member 64 to bias the locking pin 62 through the cam member 60 and an aperture 112 in the central frame member 38. And, a bias member 94 exerts a downward force on the cam member 60. For assembly purposes, when the cam member 60, locking pin 62, bias member 94 and bias member 64 are in position within the carrier 58, the carrier 58 is inserted into the bore 100 at the first end 70 of the central frame member 38. The first end 70 of the central frame member 38 is then fitted within the lower opening 68 of the housing 50. A fastener 114, such as a rivet, for example, is used to secure the central frame member 38, with the carrier 58 and cam member 60 therein, to the housing 50 as shown in FIGS. 6 and 8.

In one embodiment, the cam member 60 has a first end 120, a second end 122, a joining member 124 connecting the first end 120 and the second end 122, a first opening 126 through the joining member 124 and a second opening 128 adjacent the second end 122. The first opening 126 is preferably a slot to allow the fastener 114 to extend through the cam member 60 but to allow the cam member 60 to be able to transverse linearly within the cavity 108 of the carrier 58. In one embodiment, the second end 122 of the cam member 60 has a cam surface 130, such as an angled surface, that engages the locking pin 62. The second opening 128 allows the locking pin 62 to extend through the cam member 60 and the aperture 112 in the central frame member 38 to engage the slider member 46.

As shown in FIGS. 4-7, in one embodiment, the locking pin 62 has a first end 132, a second end 134, and two protrusions 136 extending from the locking pin 62 between the first end 132 and the second end 134. The protrusions 136 engage the cam surface 130 of the cam member 60. The first end 132 of the locking pin 62 has a beveled surface 138. The second end 134 of the locking pin 62 engages the opening 110 and bias member 64 of the carrier 58 to bias the locking pin 62 toward the aperture 112 in the central frame member 38.

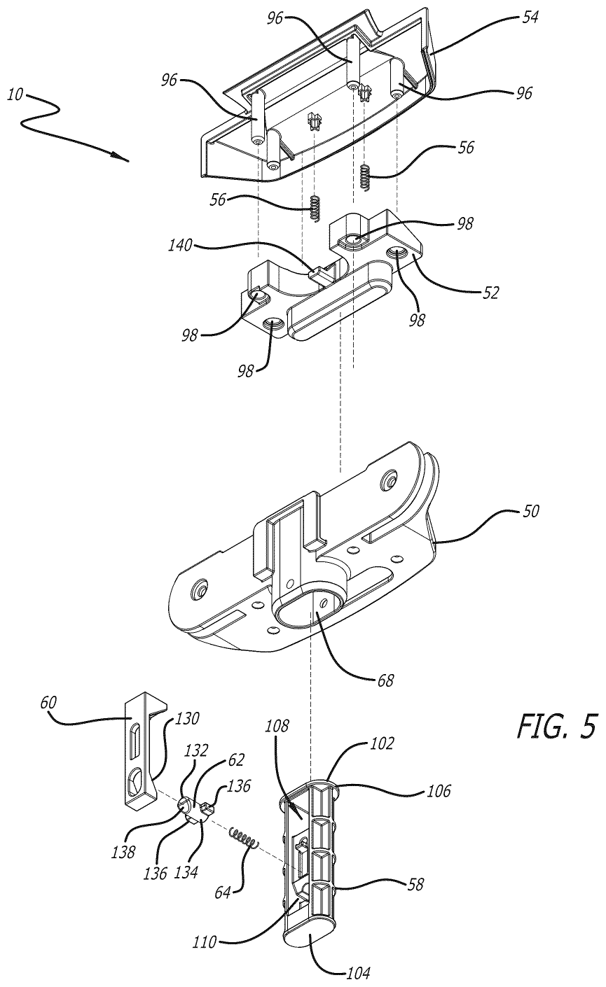

In one embodiment, as shown in FIGS. 5, 6 and 8, the push button member 52 has an extension 140 that engages the first end 120 of the cam member 60 through an opening 142 in the housing 50 (seen in FIG. 4).

Referring to FIGS. 1, 6 and 7, when the wagon 12 is in the unfolded or use state the slider member 46 is in its up position. When the push button 52 is not actuated, the bias members 94 operate to push the push button 52 away from the top cover 54. In this position, the cam member 60 is in its first or lowered position, and the locking pin 62 is in its biased position such that the first end 132 of the locking pin 62 extends through the second opening 128 in the cam member 60, the aperture 112 in the central frame member 38 and into the receiver 80 in the slider member 46 to lock the slider member 46 in place.

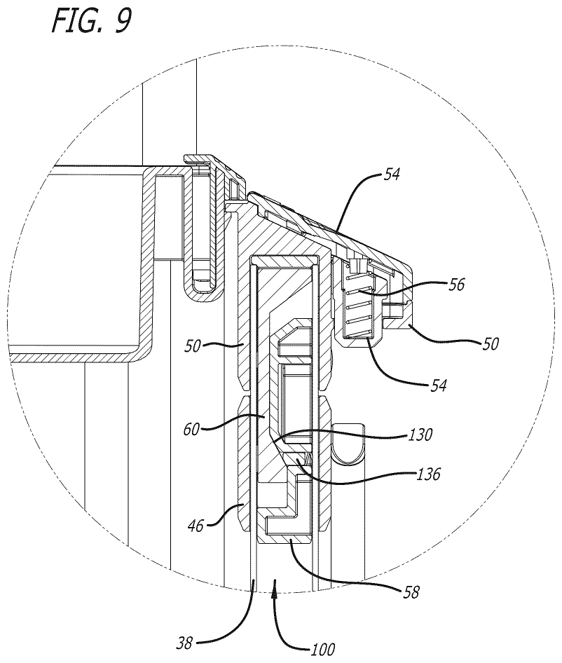

To allow the wagon 12 to be folded into its folded orientation as shown in FIG. 10, the push button 52 is actuated by squeezing the push button 52 toward the top cover 54 against the bias force of the bias members 94. As the push button 52 is moved up the extension 140 of the push button 52 engages the first end 120 of the cam member 60 to transition the cam member 60 within the cavity 108 of the carrier 58 from a lowered or first position to an upper or second position as shown in FIGS. 8 and 9. When the cam member 60 transitions from the first position to the second position the cam surface 130 of the cam member 60 engages the protrusions 136 of the locking pin 62 to axially move the locking pin 62 toward the opening 110 in the carrier 58 such that the first end 132 of the locking pin 62 disengages from the receiver 80 of the slider member 46 to unlock the slider member 46. At that point, the slider member 46 is able to move linearly on the central frame member 38 to allow the frame to collapse to a folded state.

The embodiments detailed hereinabove may be combined in full or in part, with any alternative embodiments described.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

Numerous modifications to the present disclosure will be apparent to those skilled in the art in view of the foregoing description. Preferred embodiments of this disclosure are described herein, including the best mode known to the inventors for carrying out the disclosure. It should be understood that the illustrated embodiments are exemplary only, and should not be taken as limiting the scope of the disclosure.

Several alternative embodiments and examples have been described and illustrated herein. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. Additionally, the terms “first,” “second,” “third,” and “fourth” as used herein are intended for illustrative purposes only and do not limit the embodiments in any way. Further, the term “plurality” as used herein indicates any number greater than one, either disjunctively or conjunctively, as necessary, up to an infinite number. Additionally, the term “having” as used herein in both the disclosure and claims, is utilized in an open-ended manner.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the term “include,” “have,” or the like is used in the description or the claims, such term is intended to be inclusive in a manner similar to the term “comprise” as “comprise” is interpreted when employed as a transitional word in a claim. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

It will be understood that the present disclosure may be embodied in other specific forms without departing from the spirit or central characteristics thereof. The present examples and embodiments, therefore, are to be considered in all respects as illustrative and not restrictive, and the Claims are not to be limited to the details given herein. Accordingly, while the specific embodiments have been illustrated and described, numerous modifications come to mind without significantly departing from the spirit of the disclosure and the scope of protection is only limited by the scope of the accompanying Claims.

Further, the claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A wagon frame locking mechanism for a wagon, comprising:
a handle housing having a first end and a second end;
a first top frame member pivotally connected to the first end of the handle housing;
a second top frame member pivotally connected to the second end of the handle housing;
a lower support having a first end and a second end;
a central frame member of the wagon having a first end and a second end, the first end of the central frame member being connected to a bottom of the handle housing and the second end of the central frame member being connected to a top of the lower support, the central frame member having an aperture;
a slider member slidingly connected to the central frame member, the slider member having a first end, a second end, a central bore through which the central frame member extends, and a receiver;
a first bottom frame member pivotally connected to the first end of the lower support;
a second bottom frame member pivotally connected to the second end of the lower support;
a first link member having a first end and a second end, the first end of the first link member pivotally connected to the first end of the slider member, and the second end of the first link member pivotally connected to the first bottom frame member;
a second link member having a first end and a second end, the first end of the second link member pivotally connected to the second end of the slider member, and the second end of the second link member pivotally connected to the second bottom frame member;
a carrier fixedly positioned within a bore of the central frame member, the carrier having a cavity;
a cam member positioned within the cavity in the carrier, the cam member having a first end, a second end, a joining member connecting the first end and the second end, and an opening through the joining member, wherein the second end of the cam member has a cam surface, and wherein the cam member can transition generally linearly within the cavity in the carrier;
a push button slidingly connected to the housing, the push button having an extension that engages the first end of the cam member;
a locking pin positioned partially within the cavity of the carrier and extending through the opening in the cam member and the aperture in the central frame member, and into the receiver of the slider member in a use position to fix the slider member in a first position on the central frame member; and,
wherein when the push button is actuated the extension engages the cam member to transition the cam member within the cavity of the carrier from a first position to a second position, wherein when the cam member transitions from the first position to the second position the cam surface of the cam member engages the locking pin to axially move the locking pin to an open position, and wherein the locking pin is removed from the receiver in the slider member to allow the slider member to move linearly on the central frame member to allow the wagon to collapse to a folded state.

2. The wagon frame locking mechanism of claim 1, wherein the locking mechanism unlocks the slider member from the central frame member.

3. A wagon frame locking mechanism for a wagon, comprising:
a handle housing having a first end and a second end;
a central frame member of the wagon having a first end and a second end, the first end of the central frame member being connected to a bottom of the handle housing, the central frame member having an aperture;
a slider member slidingly connected to the central frame member, the slider member having a first end, a second end, a central bore through which the central frame member extends, and a receiver;
a cam member positioned within the central frame member, the cam member having a cam surface, wherein the cam member can transition generally linearly within the central frame member;
a push button slidingly connected to the housing, the push button having an extension that engages the first end of the cam member;
a locking pin partially extending through an opening in the cam member and the aperture in the central frame member, and into the receiver of the slider member in a use position to fix the slider member in a first position on the central frame member; and,
wherein when the push button is actuated the extension engages the cam member to transition the cam member from a first position to a second position, wherein when the cam member transitions from the first position to the second position the cam surface of the cam member engages the locking pin to axially move the locking pin to an open position, and wherein the locking pin is removed from the receiver in the slider member the slider member is adapted to move linearly on the central frame member to allow the wagon to collapse to a folded state.

4. The wagon frame locking mechanism of claim 3, further comprising:
a first top frame member pivotally connected to the first end of the handle housing;
a second top frame member pivotally connected to the second end of the handle housing; and,
a lower support having a first end and a second end, wherein the second end of the central frame member is connected to a top of the lower support.

5. The wagon frame locking mechanism of claim 4, further comprising a first bottom frame member pivotally connected to the first end of the lower support, and a second bottom frame member pivotally connected to the second end of the lower support.

6. The wagon frame locking mechanism of claim 5, further comprising a first link member having a first end and a second end, the first end of the first link member pivotally connected to the first end of the slider member, and the second end of the first link member pivotally connected to the first bottom frame member, and a second link member having a first end and a second end, the first end of the second link member pivotally connected to the second end of the slider member, and the second end of the second link member pivotally connected to the second bottom frame member.

7. The wagon locking mechanism of claim 3, further comprising a carrier fixedly positioned within a bore of the central frame member, the carrier having a cavity, and the cam member positioned within the cavity in the carrier.

8. The wagon locking mechanism of claim 3, wherein the cam member has a first end, a second end, a joining member connecting the first end and the second end, and an opening through the joining member, wherein the second end of the cam member has a cam surface, and wherein the cam member can transition generally linearly within the cavity in the carrier.

9. The wagon locking member of claim 8, wherein the locking pin is positioned partially within the cavity of the carrier and extends through the opening in the cam member and the aperture in the central frame member, and into the receiver of the slider member in a use position to fix the slider member in a first position on the central frame member.

10. The wagon locking member of claim 9, wherein when the push button is actuated the extension engages the cam member to transition the cam member within the cavity of the carrier from a first position to a second position, wherein when the cam member transitions from the first position to the second position the cam surface of the cam member engages the locking pin to axially move the locking pin to an open position, and wherein the locking pin is removed from the receiver in the slider member to allow the slider member to move linearly on the central frame member to allow the wagon to collapse to a folded state.

11. A wagon frame locking mechanism for a wagon frame, comprising:
a slider member slidingly connected to the wagon frame, the slider member having a receiver;
a housing for the locking mechanism;
a top cover secured to the housing;
a push button slidingly connected to the housing, the push button moveable from a first position to a second position, the push button having an extension;
bias members biasing the push button toward the first position;
a cam member adjacent the handle housing, the extension of the push button engaging the cam member to move the cam member axially;
a locking pin having a first end positioned in the receiver of the slider member to fix the slider member to the wagon frame in a use position, the locking pin engaging the cam member when the cam member is moved longitudinally by the push button, the locking pin moving linearly and transverse to the longitudinal movement of the cam member; and,
wherein when the push button is actuated the extension engages the cam member to transition the cam member from a first position to a second position, and wherein when the cam member transitions from the first position to the second position a cam surface of the cam member engages the locking pin to axially move the locking pin to an open position wherein the locking pin is removed from the receiver in the slider member to allow the slider member to move linearly on the wagon frame member to allow the frame to collapse to a folded state.

12. The wagon frame locking mechanism of claim 11, further comprising:
a first top frame member pivotally connected to a first end of the housing;
a second top frame member pivotally connected to a second end of the housing;
a lower support having a first end and a second end;
a central frame member of the wagon frame having a first end and a second end, the first end of the central frame member being connected to a bottom of the housing and the second end of the central frame member being connected to a top of the lower support, the central frame member having an aperture.

13. The wagon locking mechanism of claim 12, wherein the slider member is slidingly connected to the central frame member.

14. The wagon locking mechanism of claim 11, wherein the slider member has a first end, a second end, and a central bore through which the central frame member extends.

15. The wagon locking mechanism of claim 11, further comprising a first bottom frame member pivotally connected to the first end of the lower support, and a second bottom frame member pivotally connected to the second end of the lower support.

16. The wagon locking mechanism of claim 15, further comprising a first link member having a first end and a second end, the first end of the first link member pivotally connected to the first end of the slider member, and the second end of the first link member pivotally connected to the first bottom frame member, and a second link member having a first end and a second end, the first end of the second link member pivotally connected to the second end of the slider member, and the second end of the second link member pivotally connected to the second bottom frame member.

17. The wagon locking mechanism of claim 11, further comprising a central frame member of the wagon frame, a carrier fixedly positioned within a bore of the central frame member, the carrier having a cavity, and the cam member positioned within the cavity in the carrier.

18. The wagon locking mechanism of claim 17, wherein the cam member has a first end, a second end, a joining member connecting the first end and the second end, and an opening through the joining member, wherein the second end of the cam member has a cam surface, and wherein the cam member can transition generally linearly within the cavity in the carrier.

19. The wagon locking member of claim 17, wherein the locking pin is positioned partially within the cavity of the carrier and extends through the opening in the cam member and the aperture in the central frame member, and into the receiver of the slider member in a use position to fix the slider member in a first position on the central frame member.

20. The wagon locking member of claim 19, wherein when the push button is actuated the extension engages the cam member to transition the cam member within the cavity of the carrier from a first position to a second position, wherein when the cam member transitions from the first position to the second position the cam surface of the cam member engages the locking pin to axially move the locking pin to an open position, and wherein the locking pin is removed from the receiver in the slider member to allow the slider member to move linearly on the central frame member to allow the wagon to collapse to a folded state.
